(19) United States
(12) Patent Application Publication
(10) Pub. No.: US 2009/0067821 A1
(43) Pub. Date: Mar. 12, 2009

(54) METHOD FOR RECORDING NAVIGATION INFORMATION ON A RECORDING MEDIUM

(75) Inventors: Duk Sung Kim, Seoul (KR); Myung Hun Kang, Kyunggi-do (KR); Yong Hoon Choi, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/911,943

(22) PCT Filed: Apr. 18, 2006
(86) PCT No.: PCT/KR2006/001422

§ 371 Date: Apr. 23, 2008

(30) Foreign Application Priority Data
Apr. 18, 2005 (KR) 10-2005-0031779

(51) Int. Cl. H04N 5/00

(52) U.S. Cl. 386/126; 386/E05.068

(57) ABSTRACT

The present invention records A/V data and navigation information in a first format such as DVD-Video format when a disk apparatus, e.g., a DVD recorder conducts data recording operation. During the recording operation, video object unit search information ‘VOBU_SRI’ among data search information ‘DSI’ contained in the navigation information is recorded in a second format such as DVD+R or DVD+RW format, thereby reducing size of the navigation information to be recorded on an optical disk.

### TECHNICAL FIELD

The present invention relates to a method of recording navigation information on a recording medium such as an optical disk.

### BACKGROUND ART

Generally, optical disk devices, such as Digital Versatile Disk (DVD) recorders, capable of recording high-image quality video data and high-sound quality audio data for a long period of time have been developed, put to the market, and widely commercialized. For example, the DVD recorder, as illustrated in FIG. 1, may be constructed to include an optical disk 10, an optical pickup 11, a Video Disk Recorder (VDR) system 12, a microcomputer 13, an On-Screen Display (OSD) generator 14, and memory 15.

Meanwhile, at the request of a user, the microcomputer 13 records Audio and Video (A/V) data, which is input from outside, on the optical disk 10 by controlling the operation of the VDR system 12. For example, the microcomputer 13 performs a series of data recording operations of encoding and processing the A/V data in a preset DVD-Video format using a Moving Picture Experts Group (MPEG) method and then recording it on the optical disk.

Furthermore, the microcomputer 13 creates and records navigation information, which is used to control the playback of the A/V data recorded as described above, in a DVD-video format. For example, as illustrated in FIG. 2, in a video title set VTS, which is navigation information created and recorded in the DVD-Video format, are included and recorded video title set Information VTSI, a video title set menu VTSM, a presentation control information PCI, and optional data search information DSI.

Furthermore, in the video title set VTS are included and recorded a video title set title VTSTT, representation control information PCI, and data search information DSI. In the data search information DSI are assigned and recorded data search information general information DSI_GI, seamless playback information SML_PBI, angle information for seamless playback SML_AGLI, video object unit search information VOBU-SRI, synchronous information SYNCI, and a reserved field RESERVED.

Furthermore, in the video object unit search information VOBU_SRI are recorded 240 pieces of forward information [1]˜[240] and 240 pieces of backward information [1]˜[240]. The data search information DSI in which the above-described information, as illustrated in FIG. 3, is recorded is recorded in the forward portion of each video object unit VOBU # in the form of a navigation pack NV_PCK #. In the navigation pack NV_PCK # are recorded a presentation control information packet PCI_PKT # and a data search information packet DSI_PKT #.

In the meantime, in the case of, for example, recording one title or one program chain on a 4.7 GByte DVD in a DVD-Video format, the microprocessor 13 assigns a maximum of 255 pieces of cell information. A minimal recording size corresponding to a single cell is approximately 18.43 MByte, which is obtained by dividing 4.7 GByte by 255.

However, the memory 15 included in the DVD recorder must have a recording capacity higher than 18.43 MByte, which is the minimal recording size corresponding to a single cell. For this purpose, for example, memory having 32 MByte, which is higher than 18.43 MByte, is normally used, so that there is a problem in that the simplification of the construction of hardware is hindered.

Furthermore, in the case where the recording capacity of the memory is lower than 18.43 MByte, not all of the data corresponding to a single cell can be buffered, so that the data must be divided into a plurality of cells. Accordingly, there occurs a problem in that a title limited to a maximum of 255 cells is divided into a plurality of titles and the plurality of titles are recorded, regardless of a user's intention.

### DISCLOSURE OF THE INVENTION

Accordingly, the present invention has been made keeping in mind the above problems occurring in the prior art, and an object of the present invention is to provide a method of recording navigation information on an optical disk, which, in the case of performing a data recording operation in an optical disk device, such as a DVD recorder, can record A/V data and navigation information on an optical disk in a first format, such as a DVD-Video format, with part of the data search information DSI of the navigation information being simply created and recorded in a second format, such as a DVD+Recordable (R) format or DVD+Rewritable (RW) format.

A method of recording navigation information on an optical disk according to the present invention includes a first step of recording A/V data and navigation information on the optical disk in a preset first format during a data recording operation; and a second step of creating and recording part of the data search information of the navigation information in a second format that is different from the first format.

In an embodiment according to the present invention, the first step records the A/V data and the navigation information on the optical disk in a preset DVD-Video format during the data recording operation, and the second step creates and records the part of the data search information of the navigation information in a DVD+R format or DVD+RW format.

### BRIEF DESCRIPTION OF THE DRAWINGS

FIG. 1 illustrates the construction of a general optical disk device;

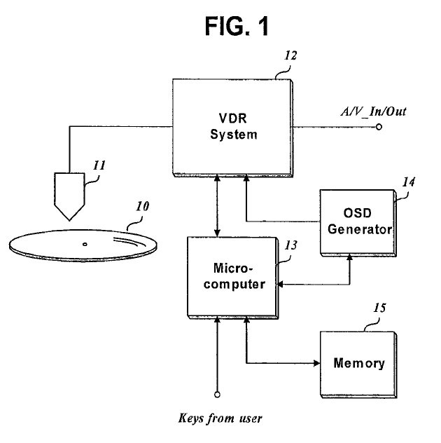

FIG. 2 illustrates an embodiment of navigation information recorded and managed by the general optical disk device;

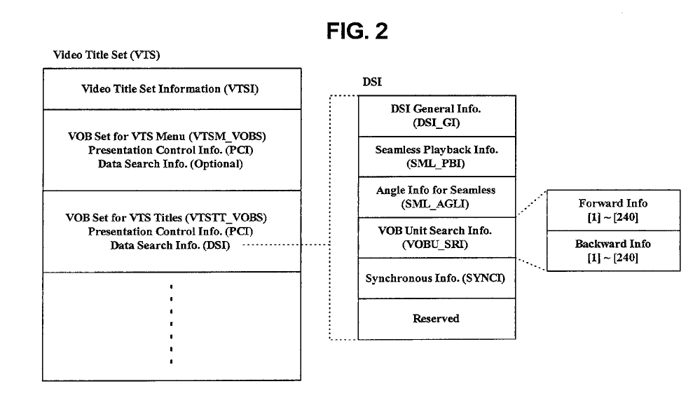

FIG. 3 illustrates an embodiment of a video object unit recorded and managed by the general optical disk device;

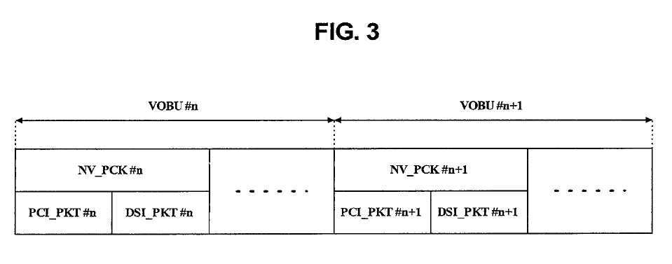

FIG. 4 is a flowchart of a method of recording navigation information on an optical disk according to the present invention;

FIG. 5 illustrates an embodiment of the navigation information recorded and managed using the method of recording navigation information on an optical disk; and

FIG. 6 illustrates an embodiment of video object unit search information recorded and managed using the method of recording navigation information on an optical disk.

### BEST MODE FOR CARRYING OUT THE INVENTION

A preferred embodiment of a method of recording navigation information on an optical disk according to the present invention is described with reference to the accompanying drawings in detail below.

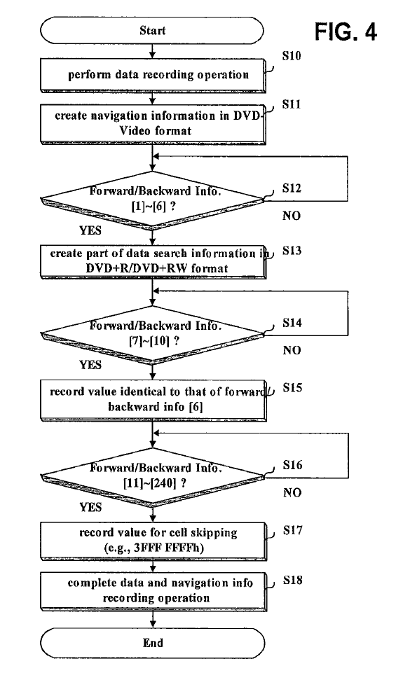

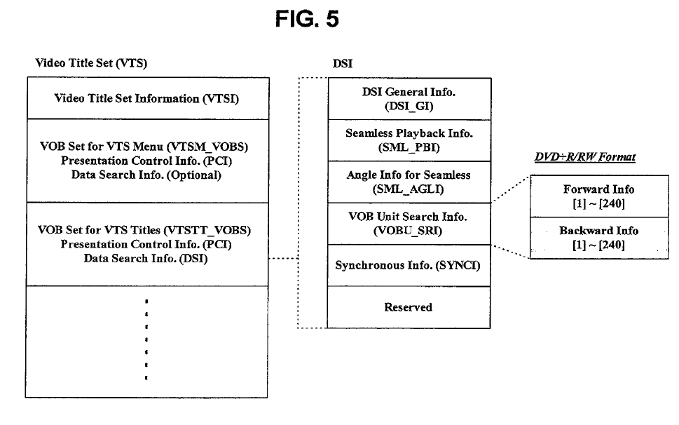

First, the method of recording navigation information on an optical disk according to the present invention may be applied to an optical disk device, such as the DVD recorder constructed as described above with reference to FIG. 5. For example, as illustrated in FIG. 4, in the case of performing a data recording operation at the request of the user, the microcomputer 13 controls the operation of a VDR system 12, thereby performing a series of data recording operations of performing MPEG encoding and signal processing on A/V data input from the outside in a preset DVD-Video format and recording the data on the optical disk at step S10.

Furthermore, the microprocessor 13 creates and records navigation information for controlling the playback of the A/V data, which is recorded as described above, in a DVD-Video format at step S11. As illustrated in FIG. 5, in a video title set, that is, navigation information created and recorded in the DVD-Video format, are included and recorded video title set information VTSI, a video title set menu VTSM, presentation control information PCT, and optional data search information DSI.

Furthermore, in the video title set VTS are included and recorded a video title set title VTSTT, representation control information PCI, and data search information DSI. In the data search information DSI are assigned and recorded data search information general information DSI_GI, seamless playback information SML_PBI, angle information for seamless playback SML_AGLI, video object unit search information VOBU_SRI, synchronous information SYNCI, and a reserved field RESERVED.

Furthermore, in the video object unit search information VOBU_SRI are recorded 240 pieces of forward information [1]˜[240] and 240 pieces of backward information [1]˜[240]. In the case of creating and recording the above-described video object unit search information VOBU_SRI, the microprocessor 13 simply creates and records the 240 pieces of forward information [1]˜[240] and the 240 pieces of backward information [1]˜[240] in a DVD-Recordable (R) format or DVD-Rewritable (RW) format instead of a DVD-Video format.

For example, in the case of creating the forward information [1]˜[6] or backward information [1]˜[6] of the video object unit search information VOBU_SRI during a data recording operation at step S12, the microprocessor 13 uses the DVD+R format or DVD-RW format instead of the DVD-Video format at step S13. In this case, for the created forward information [1]˜[6] or backward information [1]˜[6], the same unique forward or backward information is created and recorded as when the DVD-Video format is used.

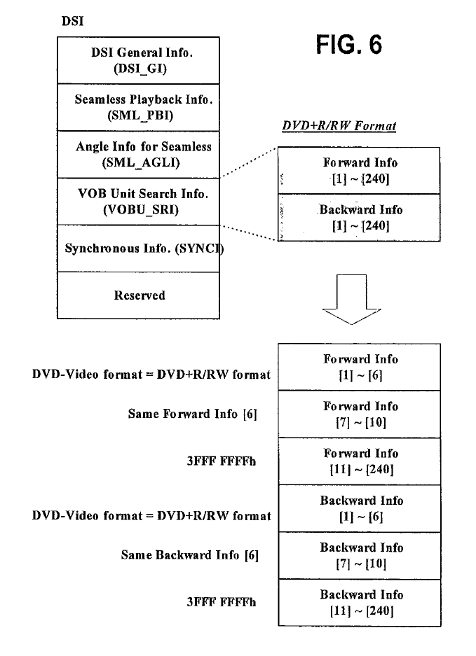

Meanwhile, as illustrated in FIG. 6, in the case of creating the forward information [7]˜[10] or backward information [7]˜[10] of the video object unit search information VOBU_SRI at step S14, the microprocessor 13 repeatedly records a value identical to that of the previously created forward information [6] or backward information [6] in the forward information [7]˜[10] or backward information [7]˜[10] at step S15.

Thereafter, in the case of creating the forward information [11]˜[240] or backward information [11]˜[240] of the video object unit search information VOBU_SRI at step S16, the microprocessor 13 creates and records a preset value, for example, ‘3FFF FFFFh’, for cell skipping in the forward information [11]˜[240] or backward information [11]˜[240] at step S17 and, thereafter, completes the performance of a data and navigation recording operation at step S18.

Accordingly, the microprocessor 12 can perform a corresponding search operation in the case of searching for and referring to the forward information [1]˜[6] or backward information [1]˜[6] during a data playback operation at the request of the user, and performs a search operation corresponding to the forward information [6] or backward information [6] in the case of referring to the forward information [7]˜[10] or backward information [7]˜[10].

Furthermore, in the case of searching for and referring to the forward information [11]˜[240] or backward information [11]˜[240], an operation of skipping to another cell is performed according to the preset value (for example, 3FFF FFFFh). If the video object unit search information VOBU_SRI is more simply created and recorded using the DVD+R format or DVD+RW format, as in the present invention, the amount of data corresponding to a single cell can be significantly reduced, for example, 8 MByte of memory can be used, so that the construction of hardware can be simplified.

Furthermore, a title limited to a maximum of 255 cells can be preemptively prevented from being divided into a plurality of titles and then being recorded, regardless of the user's intention due to the lack of the capacity of memory.

The method of recording navigation information on an optical disk according to the present invention, which is described in detail using the restrictive embodiments, can simplify navigation information to be recorded on an optical disk, and can normally and continuously perform data recording operations in the state in which the capacity of memory included in an optical disk device has been reduced.

The above-described preferred embodiments of the present invention are disclosed for illustrative purposes. Those skilled in the art can achieve modifications, variations, substitutions or additions associated with various other embodiments within the spirit and technical scope of the present invention disclosed in the accompanying claims.

1. A method of recording navigation information on an optical disk, comprising:
a first step of recording Audio and Video (A/V) data and navigation information on the optical disk in a pre-defined first format during a data recording operation; and
a second step of creating and recording a part of data search information pertaining to the navigation information in a second format other than the first format.

2. The method as set forth in claim 1, wherein the first step records the A/V data and the navigation information on the optical disk in a pre-defined Digital Versatile Disk (DVD)-Video format during the data recording operation.

3. The method as set forth in claim 1, wherein the second step creates and records the part of the data search information pertaining to the navigation information in a DVD+Recordable (R) format or DVD+Rewritable (RW) format.

4. The method as set forth in claim 1, wherein the part of the data search information is video object unit search information VOBU_SRI.

5. The method as set forth in claim 4, wherein forward/backward information [1]˜[6] of the video object unit search information is recorded using unique values, forward/backward information [7]˜[10] of the video object unit search information is recorded using a unique value identical to a value of the forward/backward information [6], and forward/backward information [11]˜[240] of the video object unit search information is recorded using a preset value for cell skipping.
